(19) United States
(12) Patent Application Publication
(10) Pub. No.: US 2005/0198336 A1
(43) Pub. Date: Sep. 8, 2005

(54) Methods and apparatuses for automatic adaptation of different protocols

(76) Inventors: Edward Eytchison, Milpitas, CA (US); Dan M. Phan, San Jose, CA (US); Saket Kumar, Sunnyvale, CA (US)

Correspondence Address: Valley Oak Law, #106, 5655 Silver Creek Valley, San Jose, CA, 95138, US

(21) Appl. No.: 10/763,866

(22) Filed: Jan. 22, 2004

(51) Int. Cl. G06F 15/16

(52) U.S. Cl. 709/230; 709/246

(57) ABSTRACT

Methods and apparatuses are described for translating commands formatted in different protocols into a common application programming interface. Methods and apparatuses detect at least one device; detect a protocol associated with each device; match the protocol with a protocol translator module; and translate a command formatted in the protocol into a translated command formatted in a common application programming interface through the protocol translator module.

### FIELD OF INVENTION

The present invention relates generally to discovering services and, more particularly, to discovering services through a network.

### BACKGROUND

With the proliferation of computer networks, in particular the Internet, there are an increasing number of applications directed toward displaying content.

In addition, there is a proliferation of unique web-based approaches and proprietary technologies for distributing audio/visual content and services. Many proprietary solutions exist to view audio/visual content. However as competing proprietary solutions have flourished, the ability to discover and view incompatible audio/visual content and services has been increasingly frustrating to users.

For example, a typical user is responsible for finding the appropriate solution to view a specific audio/visual content and/or service. Without the appropriate solution that corresponds to the specific content and service, the user may not be able to view the content.

Because of the nature of these proprietary solutions and the constant proliferation of new proprietary solutions, it has been difficult for users to discover and receive incompatible audio/visual content and services across dissimilar boundaries and networks.

### SUMMARY

Methods and apparatuses are described for translating commands formatted in different protocols into a common application programming interface. Methods and apparatuses detect at least one device; detect a protocol associated with each device; match the protocol with a protocol translator module; and translate a command formatted in the protocol into a translated command formatted in a common application programming interface through the protocol translator module.

Network translator modules act as translators between a plurality of network protocols and a single, common application programming interface (API) for network communication. Each unique translator module translates between the common API and a corresponding unique network protocol. In one instance, each translator module implements all the functions of the common API. The translator modules are modeled as a translation layer between one or more run time processes (applications, intermediate modeled layer (e.g., presentation layer), or service module (e.g., audiovisual service module, non-audiovisual service model)), that use the common API and the underlying networks that use various network protocols. Illustrative network protocols include digital home network protocols, peer-to-peer protocols, wireless communication protocols, local area network protocols, wide area network protocols, and protocols associated with The Internet (global network of interconnected networks), e.g., associated with the World Wide Web.

At run time on a computing platform, an illustrative application includes a list of network protocols that are available for use. The application itself, or an intermediary library, loads a translator module that is associated with a particular listed network protocol to be used. After the translator module is loaded, the application uses the common API regardless of the underlying network protocol being used. To use another listed network protocol, the application or intermediary library loads the translator module that is associated with the new network protocol, and the application continues to use the common API. In this manner, for instance, a single application is able to communicate using both a “universal plug-and-play” type protocol (e.g., UPnP protocol promoted by the UPnP Forum) network and a non-“universal plug-and-play” type network. Other applications that may be run on the computing platform are also designed to use the common API. Thus applications are developed to use only the common API for communication, and without the need for additional elements (e.g., a large number of compiled run time libraries) required for APIs specific to a plurality of network protocols.

Among the further advantages of this architecture is a higher run time efficiency because the application and the translator module run in the same process address space. No undue process overhead is necessary since no interprocess messaging is needed from the application to any process that proxies for the underlying network being used. The architecture provides a “lightweight” run time binding of network protocol translators.

Another advantage of this architecture is that the application does not have to be recompiled or relinked in order to use a new network protocol. The network protocol translator modules are available as “plug-ins” to the application. Applications are not required to be “heavyweight” because they do not require large, compiled libraries in order to communicate with various network protocols.

Yet another advantage is that a list of supported network protocols is available at run time. In automatic embodiments, a software agent detects the presence of networks that use, for example, protocols designed for use with audiovisual content (e.g., protocols promoted by the Digital Home Working Group). The software agent, which can easily be made updatable, includes a list of known network protocols and actions necessary to query for the existence of available networks that use the listed protocols. For example, in one instance the software agent (a “control point” application in UPnP terminology) detects UPnP networks by sending out multicast M-search messages to discover devices. Once an available network is detected, the software agent registers (e.g., in the WINDOWS registry) the available network protocol type and the name of the associated translator module, and then the software agent copies the associated translator module from a central repository to an accessible location in preparation for use. Therefore, along with the “plug-in” feature of the translator modules, there is automatic discovery of network protocols and automatic adaptation of different network protocols. In other embodiments, however, one or more protocols on the application's list of protocols are explicitly made available by installing support for a particular network protocol.

Still another advantage is that it is possible to obtain the supported protocols during run time. In one embodiment, the protocol translation system is made flexible to environmental changes by keeping required information in an Extensible Markup Language (XML) document. The XML (instance) document outlines the details of the protocols (e.g., uniform resource locators (URLs) of drivers, features, run constraints, requirements, etc.). At start up the system reads the instance document from a remote location, and then it determines where and how to obtain the necessary drivers (protocol proxy) and how to load them.

In one embodiment, the single, common API is developed by taking the most common features of network protocols, such as UPnP or Server Message Block (SMB) or Digital Home Working Group protocols, and then extending the API to include certain specific features of the network protocols. If the API attempts to access a particular feature supported by one network protocol bu not supported by the underlying network protocol presently in use, an error message (e.g., “Feature not supported”) is returned.

In one embodiment, instead of using APIs the protocols communicate with the system by using, for example, a pre-defined XML document. The document is flexible to allow for different protocols. A set of pre-defined tags is defined, and new tags are added as new technologies emerge.

Thus, a common API for network communication allows the development of applications to search, browse, and engage content (e.g., audiovisual content items) regardless of underlying network protocols and without incurring undue processing overhead. Further, the developed applications are easily adapted to any new network protocol without having to recompile or relink.

### BRIEF DESCRIPTION OF THE DRAWINGS

The accompanying drawings, which are incorporated in and constitute a part of this specification, illustrate and explain one embodiment of the methods and apparatuses for automatic adaptation of different protocols. In the drawings,

FIG. 1 is a diagram illustrating an environment within which the methods and apparatuses for automatic adaptation of different protocols are implemented.

FIG. 2 is a simplified block diagram illustrating one embodiment in which the methods and apparatuses for automatic adaptation of different protocols are implemented.

FIG. 3 is a simplified block diagram illustrating an exemplary embodiment in which the methods and apparatuses for automatic adaptation of different protocols are implemented.

FIG. 4 is a simplified block diagram illustrating an exemplary embodiment of a registry architecture in which the methods and apparatuses for automatic adaptation of different protocols are implemented.

FIG. 5 is a simplified block diagram illustrating an exemplary data, consistent with one embodiment of the methods and apparatuses for automatic adaptation of different protocols.

FIG. 6 is a flow diagram, consistent with one embodiment of the methods and apparatuses for automatic adaptation of different protocols.

FIG. 7 is a flow diagram, consistent with one embodiment of the methods and apparatuses for automatic adaptation of different protocols.

### DETAILED DESCRIPTION

The following detailed description of the methods and apparatuses for automatic adaptation of different protocols refers to the accompanying drawings. The detailed description illustrates embodiments of the methods and apparatuses for automatic adaptation of different protocols and not intended to construct limitations. Instead, the scope of the invention is defined by the claims.

Those skilled in the art will recognize that many other implementations are possible and are consistent with the methods and apparatuses for automatic adaptation of different protocols. Coding of the various embodiments will be routine in view of this description.

References to “content” includes data such as audio, video, text, graphics, and the like, that are embodied in digital or analog electronic form. References to “applications” includes user data processing programs for tasks such as word processing, audio output or editing, video output or editing, digital still photograph viewing or editing, and the like, that are embodied in hardware and/or software.

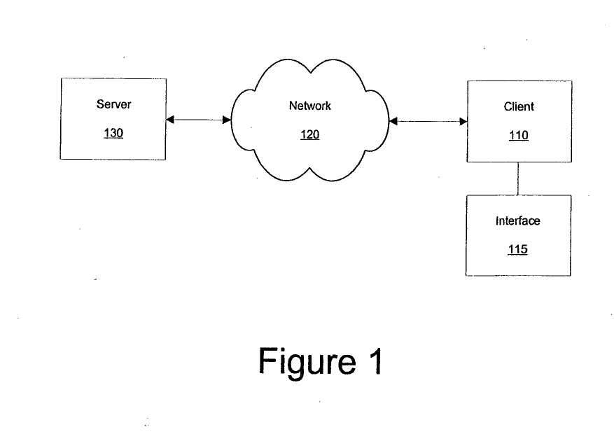

FIG. 1 is a diagram illustrating an environment within which the methods and apparatuses for automatic adaptation of different protocols are implemented. The environment includes an electronic device 110 (e.g., a computing platform configured to act as a client device, such as a personal computer, a personal digital assistant, a cellular telephone, a paging device, a device in an in-home network), a user interface 115, a network 120 (e.g., a local area network, a home network, the Internet), and a server 130 (e.g., a computing platform configured to act as a server).

In some embodiments, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device (mouse, trackball, etc.), a microphone, a speaker, a display, a camera) are physically separate from, and are conventionally coupled to, electronic device 110. The user uses interface 115 to access and control content and applications stored in electronic device 110, server 130, or a remote storage device (not shown) coupled via network 120.

In accordance with the invention, embodiments of automatic adaptation of different protocols as described below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

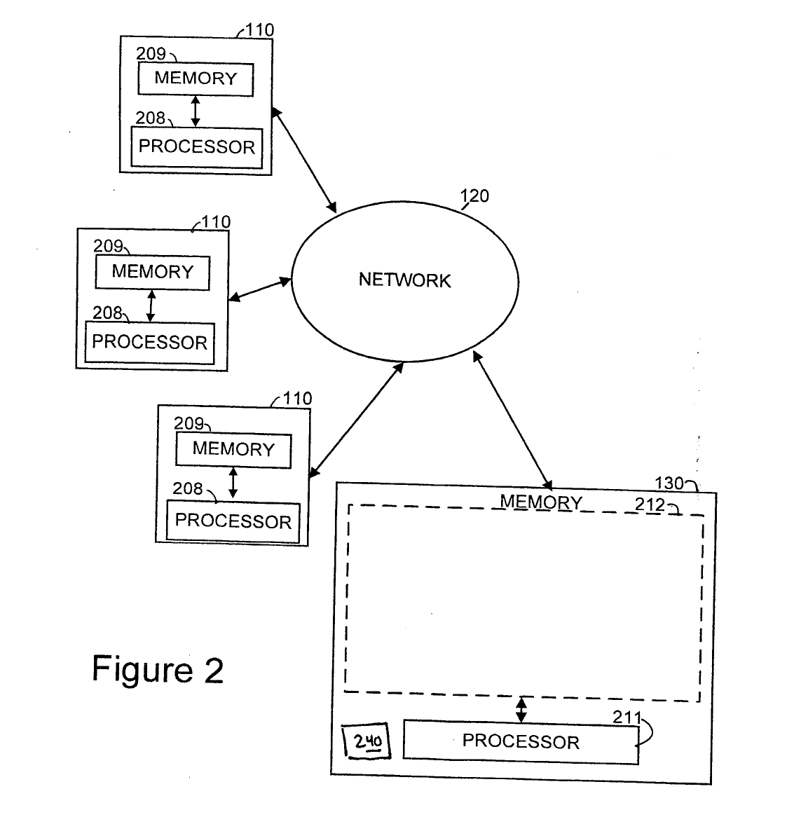

FIG. 2 is a simplified diagram illustrating an exemplary architecture in which the methods and apparatus for automatic adaptation of different protocols are implemented. The exemplary architecture includes a plurality of electronic devices 110, a server 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server 130 includes a processor 211 coupled to a computer-readable medium 212. In one embodiment, the server 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

One or more user applications are stored in media 209, in media 212, or a single user application is stored in part in one media 209 and in part in media 212. In one instance a stored user application, regardless of storage location, is made customizable based on automatic adaptation of different protocols as determined using embodiments described below.

The plurality of client devices 110 and the server 130 include instructions for a customized application for automatic adaptation of different protocols. In one embodiment, the plurality of computer-readable media 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

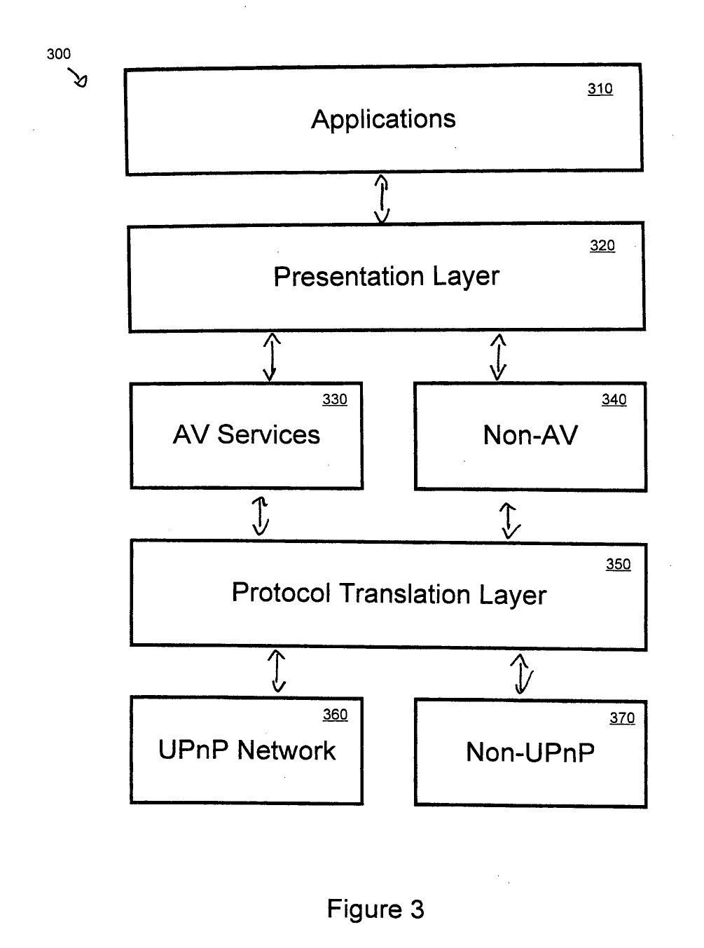

FIG. 3 is a simplified diagram illustrating an exemplary architecture of a system 300. In one embodiment, the system 300 is embodied within the electronic device 110. In another embodiment, the system 300 is embodied within the server 130. In one embodiment, the system 300 includes applications 310, a presentation layer 320, an audio/visual services module 330, a non-audio/visual services module 340, a protocol translation layer 350, a universal plug and play (e.g., UPnP) network 360, and a non-universal plug and play network 370. Overall, the system 300 is configured to allow the applications 310 to seamlessly interface through the network 360 and the network 370.

In some embodiments, the applications 310 are utilized by a user. In one instance, one or more applications 310 support a user acting as a content developer who creates and/or modifies content for viewing by others. In another instance, one or more applications 310 support a content viewer who consumes available content.

In some embodiments, the presentation layer 320 processes the content information in a suitable format for use by the applications 310.

In some embodiments, the audio/visual service module 330 stores and maintains device information representing devices that are associated with audio/visual services. Such audio/visual services include music, videos, photos, graphics, text, documents, and the like. In other embodiments, the audio/visual service module 330 also stores and maintains listings or indices of audio/visual content items that are stored at a location outside of the system 300.

In some embodiments, the non-audio/visual service module 340 stores and maintains device information representing devices that are associated with non-audio/visual services. Such non-audio/visual services include printing documents, faxing documents, and the like. In other embodiments, the non-audio/visual service module 340 stores and maintains listings or indices of non-audio/visual content items that are stored at a location outside of the system 300.

In some embodiments, the protocol translation layer 350 translates commands utilizing at least one underlying protocol into translated commands utilizing a common application programming interface suitable for use by the applications 310, the presentation layer 320, the audio/visual service module 330, and/or the non-audio/visual service module 340. For example, in one instance the protocol translation layer 350 translates a command formatted in the UPnP protocol from the UPnP network 360 into a translated command formatted in the common application programming interface for use by the system 300.

In other embodiments, the protocol translation layer 350 handles the translation of commands formatted in a plurality of different protocols into translated commands formatted in the common application programming interface. The protocol translation layer 350 supports more than one network protocol. For example, in one instance the protocol translation layer 350 stores more than one translation module for translating commands in multiple different protocols into the common application programming interface. In another instance, the protocol translation layer 350 retrieves an appropriate translation module in response to the protocol to be translated.

In some embodiments, the translation modules are stored within the protocol translation layer 350. In other embodiments, the translations modules are stored in a remote location outside the system 300.

In one embodiment, the UPnP network 360 utilizes a protocol established by UPnP.

In one embodiment, the non-UPnP network 370 utilizes a protocol established outside of UPnP. For example, Samba and server message block (SMB) are exemplary protocols which are not related to UPnP.

In FIG. 3, the system 300 is shown with the applications 310 logically connected to the presentation layer 320; the presentation layer 320 logically connected to the audio/visual services module 330 and the non-audio/visual services module 340; modules 330/340 connected to translation layer 350; and the protocol translation layer 350 logically connected to the UPnP network 360 and the non-UPnP network 370.

The distinction between the UPnP network 360 and the non-UPnP network 370 is illustrative of one embodiment for the system 300. In other embodiments, any different number of networks and protocols are utilized within the system 300.

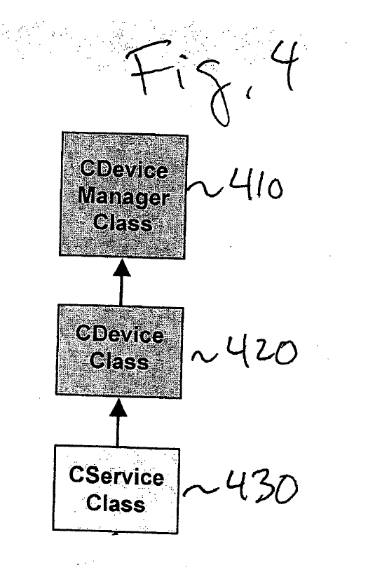

FIG. 4 is a simplified block diagram illustrating exemplary services, devices, and content organized into classes. In one embodiment, these classes are utilized by the system 300 to encapsulate and categorize information corresponding to unique content, devices, or network services that are easily accessed via two or more different network protocols by an illustrative application using a single, common API. These classes include a device manager class 410, a device class 420, and a service class 430.

In one embodiment, the device manager class 410 groups devices based on common services provided by these devices. For example, these devices are grouped together based on their common services that they provide. In some instances, the specific device has limitations on the services that are provided based on the inherent limitation of the specific device. For example, a specific device which is only capable of processing audio information cannot support video processing.

In one embodiment, the device manager class 410 groups devices in response to a GetDeviceList command that retrieves a list of devices that function using one or more specified network protocols. In some embodiments, the list of devices is further filtered and refined based on the device type and the content type supplied by the particular device. For example, device types include audio display, video display, audio capture, video capture, audio effects, video effects, and the like. Additionally, content types include documents, videos, music, photo albums, and the like.

In one embodiment, the device manager class 410 groups devices in response to a GetDeviceByName command that searches the multiple networks for a specific device. In one embodiment, the specific device is identified through a device identifier which is unique to each device. In some embodiments, the device identifier is a serial number of the device. In other embodiments, the device identifier is a descriptive name, such as compact disc player and video recorder.

In one embodiment, the device manager class 410 groups devices in response to a GetDefaultDevice command that initializes a specific device as a default for a particular device type or content type. In one embodiment, there is more than one default device for each type of content or device.

In one embodiment, the device manager class 410 groups devices in response to a GetDeviceCount command that finds the total number of devices across multiple networks.

In one embodiment, the device manager class 410 groups devices in response to a IsDeviceAvailable command that checks the status of each of the devices across multiple networks. For example, even though a particular device is discovered, the device can considered unavailable because the device is already in use or is unresponsive.

In one embodiment, the device class 420 organizes and encapsulates information associated with a specific device. In one embodiment, the device class 420 organizes devices in response to a GetDeviceID command that requests a unique identification associated with a specific device.

In one embodiment, the device class 420 organizes devices in response to a GetDeviceAttributes command that retrieves a set of predefined attributes for a specific device. For example, the set of predefined attributes includes network protocol, device type, content type, unique identifier, manufacturer, and the like.

In one embodiment, the device class 420 organizes devices in response to a GetDeviceAttributeByName command that retrieves a specific device attribute that is specified. For example, instead of returning a list of predefined attributes, only a single attribute is retrieved.

In one embodiment, the device class 420 organizes devices in response to a IsServiceAvailable command that checks the status of each of the services for devices across multiple networks. For example, even though a particular device may offer a service, the service from the device is considered unavailable because the device is already in use or is unresponsive.

In one embodiment, the device class 420 organizes devices in response to a GetServiceList command that identifies at least one service offered by each device.

In one embodiment, the device class 420 organizes devices in response to a GetServiceCount command that retrieves the number of available services associated for a specific device.

In one embodiment, the device class 420 organizes devices in response to a GetServiceByName command that retrieves instances of services identified by name.

In one embodiment, the service class 430 organizes devices based on common services provided by these devices. In one embodiment, the service class 430 organizes devices in response to a GetServiceID command that retrieves the name or identification of a service or services provided by each unique device. In one embodiment, the name of the service is standardized and established across multiple networks. For example, name of the service remains the same whether the device is configured with the UPnP network or non-UPnP network.

In one embodiment, the service class 430 organizes devices in response to a GetParentDevice command that identifies the device which is hosting a particular service.

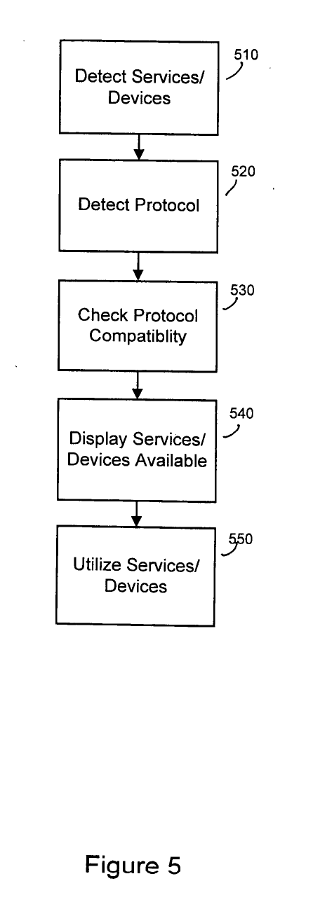

The flow diagrams as depicted in FIGS. 5, 6, and 7 illustrate embodiments of the invention. In each embodiment, the flow diagrams illustrate various exemplary functions executed by the system 300.

The blocks within the flow diagram can be performed in a different sequence without departing from the spirit of the methods and apparatuses for automatic adaptation of different protocols. Further, blocks may be deleted, added, or combined without departing from the spirit of the methods and apparatuses for automatic adaptation of different protocols.

FIG. 5 is a flow diagram that illustrates how a protocol is translated through the system 300.

In Block 510, services and/or devices are detected. In one embodiment, these services and/or devices span more than one network and utilize more than one protocol to interface with other services and/or devices.

In Block 520, a corresponding protocol is detected for each of the services and/or devices detected in 510. Multiple ways to detect the protocols are demonstrated in greater detail within the description of classes corresponding with the FIG. 4. In Block 530, a check is performed to ensure that the protocol identified with a particular service and/or device is supported by the methods and apparatuses for automatic adaptation of different protocols. For example, for the protocol to be supported, the system 300 is capable of translating the protocol of the particular service and/or device into the common application programming interface for use with the applications 310 associated with the system 300.

In Block 540, the services and/or devices that correspond to protocols supported by the methods and apparatuses for automatic adaptation of different protocols are displayed. Services and/or devices corresponding to protocols not supported by the methods and apparatuses for automatic adaptation of different protocols are not displayed.

In Block 550, the services and/or devices displayed are made available to be utilized through translated commands formatted in the common application programming interface by the applications 310 as shown within FIG. 3.

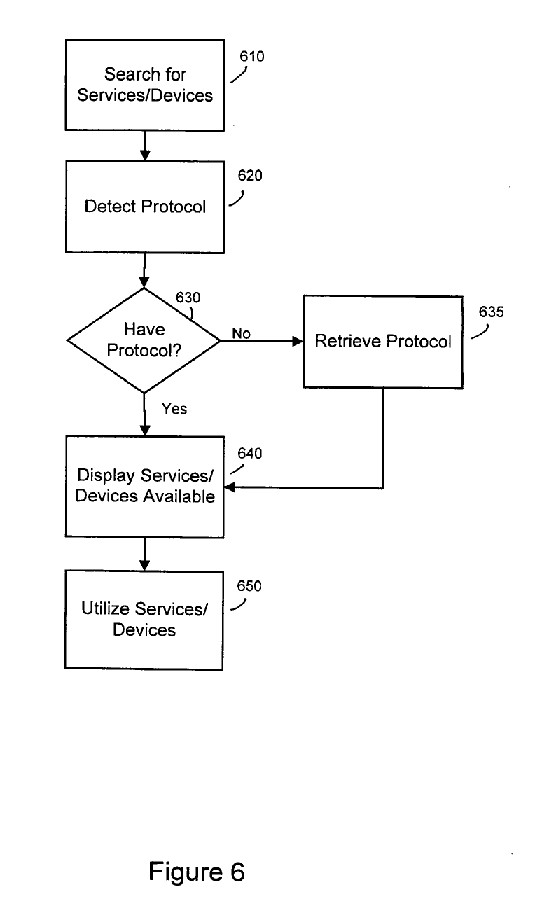

FIG. 6 is a second flow diagram that illustrates how a protocol is translated through the system 300.

In Block 610, services and/or devices are searched. Services and/or devices are configured to be searched by numerous parameters. Exemplary parameters are found in the description of the different classes illustrated in FIG. 4. In some embodiments, services and/or devices are identified and filtered through these various parameters including, but not limited to, device/service availability, associated protocol, type of service, type of device, and the like. In some embodiments, these services and/or devices span more than one network and utilize more than one protocol to interface with the services and/or devices.

In Block 620, a corresponding protocol is detected for each of the services and/or devices searched in 610. Multiple ways to detect the protocols are demonstrated in greater detail within the description of classes corresponding with the FIG. 4.

In Block 630, the system checks if the protocol identified with a particular service and/or device is supported by the methods and apparatuses for automatic adaptation of different protocols. For example, for the protocol to be supported, the system 300 is capable of translating the protocol of the particular service and/or device into the common application programming interface for use with the applications associated with the system 300. In some embodiments, the protocol is translated through the protocol translation layer 350. In addition, in some embodiments, a protocol translation module corresponding with the particular protocol is utilized within the protocol translation layer 350.

If the protocol translation module is not found for the particular protocol, a protocol translation module is retrieved from a remote location outside the protocol translation layer 350 in Block 635.

In Block 640, the services and/or devices that correspond to protocols supported are displayed. Services and/or devices corresponding to protocols not supported are not displayed. For example, if a proper protocol translation module cannot be found for the particular protocol, then the associated service or device is not supported by the system 300.

In Block 650, the services and/or devices displayed are made available to be utilized through translated commands formatted in the common application programming interface by the applications 310 as shown within FIG. 3.

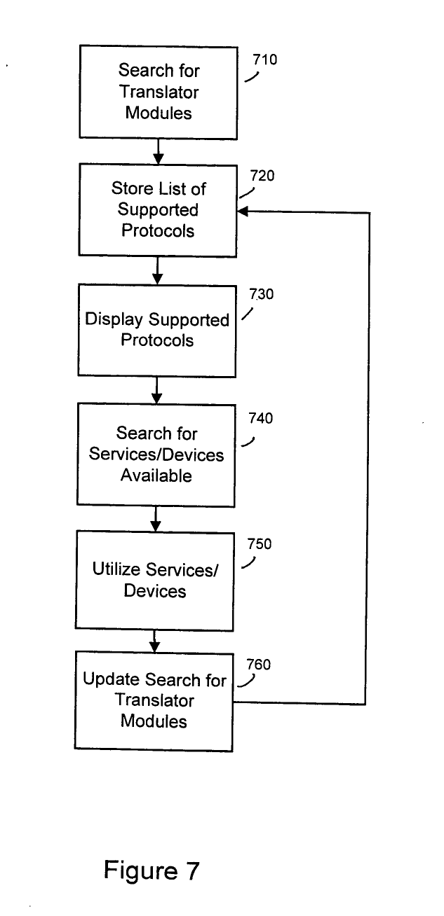

FIG. 7 is third a flow diagram that illustrates how a protocol is translated through the system 300.

In Block 710, translator modules are detected. In one embodiment, the translator modules are utilized by the protocol translator layer 350 for translating commands of one protocol into a common application programming interface. In some embodiments, translator modules reside locally within the protocol translation layer 350. In other embodiments, translator modules reside in a remote location outside of the system 300.

In Block 720, a list of supported protocols are stored. The list of supported protocols corresponds to the protocols associated with the detected translator modules.

In Block 730, the list of supported protocols is displayed.

In Block 740, the services and/or devices that correspond to supported protocols are displayed. Services and/or devices corresponding to protocols not supported are not displayed. For example, if a proper protocol translation module cannot be found for the particular protocol, then the associated service or device is not supported.

In Block 750, the services and/or devices displayed are made available to be utilized through translated commands formatted in the common application programming interface by the applications 310 as shown within FIG. 3.

In Block 760, an updated search for translator modules is performed. If additional or fewer translator modules are found, then the list of supported protocols within the Block 720 is also updated based on the updated search. In some embodiments, the updated search is continuously performed. In other embodiments, the updated search is performed on a predetermined time interval.

1. A method comprising:
detecting at least one device;
detecting a protocol associated with each device;
matching the detected protocol with a protocol translator module; and
using a protocol translator module to translate a command formatted in the protocol into a translated command formatted in a common application programming interface.

2. The method according to claim 1, further comprising searching for the device from a plurality of devices based on a device identifier.

3. The method according to claim 1, further comprising searching for the device from a plurality of devices based on a content type.

4. The method according to claim 1, further comprising searching for the device from a plurality of devices based on a device type.

5. The method according to claim 1, further comprising searching for the device from a plurality of devices based on a device's availability.

6. The method according to claim 1, further comprising searching for the protocol translator module.

7. A system comprising:
means for detecting at least one device;
means for detecting a protocol associated with each device;
means for matching the detected protocol with a protocol translator module; and
means for using the protocol translator module to translate a command formatted in the protocol into a translated command formatted in a common application programming interface.

8. A method comprising:
detecting at least one service;
detecting a protocol associated with each service;
matching the detected protocol with a protocol translator module; and
using a protocol translator module to translate a command formatted in the protocol into a translated command formatted in a common application programming interface.

9. A method comprising:
detecting a plurality of devices wherein each unique device communicates using a corresponding protocol; and
displaying an indication of each device if a protocol translator module is matched with the corresponding protocol.

10. The method according to claim 9, further comprising detecting the corresponding protocol from each device.

11. The method according to claim 9, further comprising storing the protocol translator module.

12. The method according to claim 9, further comprising translating a command formatted in the corresponding protocol into a translated command formatted in a common application programming interface through the protocol translator module.

13. The method according to claim 9, further comprising searching for a specific device from the plurality of devices based on a device identifier.

14. The method according to claim 9, further comprising searching for a specific device from the plurality of devices based on a content type.

15. The method according to claim 9, further comprising searching for a specific device from the plurality of devices based on a device type.

16. The method according to claim 9, further comprising searching for a specific device from the plurality of devices based on a device's availability.

17. A method comprising:
identifying a plurality of protocol translator modules wherein each protocol translator module is associated with a unique protocol;
storing a list representing the plurality of protocol translator modules;
displaying an indication of each device having a device protocol that is compatible with one of the plurality of protocol translator modules in the list; and
translating a command formatted in the device protocol into a translated command formatted in a common application programming interface through one of the plurality of protocol translator modules.

18. The method according to claim 17, further comprising searching for additional protocol translator modules.

19. The method according to claim 18, further comprising updating the index in response to the searching for additional protocol translator modules.

20. A system comprising:
an application configured for operating through a common application programming interface;
a first device configured for operating using a first protocol;
a second device configured for operating using a second protocol; and
a protocol translation layer configured for searching for a first protocol translation module corresponding to the first protocol and for searching for a second protocol translation module corresponding to the second protocol.

21. The system according to claim 20, wherein the protocol translation layer is configured for translating a first command formatted in the first protocol into a command formatted in the common application programming interface for use by the application.

22. The system according to claim 20, further comprising a presentation layer configured for displaying the first device after locating the first protocol translation module.

23. A network protocol translation system comprising:
a processor that executes a run time process that uses only a single application programming interface for network communication;
wherein the processor enables the run time process to communicate via a first network protocol by executing a first translation module that translates between the first network protocol and the application programming interface; and
wherein the processor enables the run time process to communicate via a second network protocol, different from the first network protocol, by executing a second translation module that translates between the second network protocol and the application programming interface.

24. A method, executed on a computing platform, comprising the acts of:
executing a run time process that uses only a single application programming interface for network communication;
enabling the run time process to communicate via a first network protocol by executing a first translation module that translates between the first network protocol and the application programming interface; and
enabling the run time process to communicate via a second network protocol, different from the first network protocol, by executing a second translation module that translates between the second network protocol and the application programming interface.
